(19) United States
(12) Patent Application Publication
(10) Pub. No.: US 2006/0235975 A1
(43) Pub. Date: Oct. 19, 2006

(54) Method, system and computer program for managing data transmission

(75) Inventors: Dominique Delhumeau, Carquefou (FR); Jerome Tarte, La Gaude (FR)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 11/377,464

(22) Filed: Mar. 16, 2006

(30) Foreign Application Priority Data
Apr. 19, 2005 (EP) 05300291.1

(51) Int. Cl. G06F 15/173

(52) U.S. Cl. 709/226

(57) ABSTRACT

The present invention discloses a method and system for managing data transmission. A method in accordance with the present invention includes the steps of: determining available network resources between a device and a remote server; choosing a network resource from the available network resources with a bandwidth which is greater than a bandwidth of any other available network resource; and communicating a synchronization profile to the device that matches the bandwidth of the chosen network so that a connection can be established.

### FIELD OF INVENTION

The present invention is directed to data transmission and more particularly to a method and system for managing data transmission.

### BACKGROUND ART

A user will often move around with a device (e.g., desktop, laptop, personal digital assistant, etc.) and still wish to be connected to the remote server of their companies or other systems. In fact, if the user wants to have a look at emails located on the remote server the user can use connection manager software to optimize any download to a mail client included in the device.

This optimization software will search for networks that the device may connect to in order to determine a list of the available networks. In addition, the software may also be able to give the bandwidth of the network. In terms of network performance the user would prefer to retrieve only a part of the email when the bandwidth is narrow, for example if the connection is a GPRS connection. By comparison, all emails may be downloaded if a broader bandwidth is available.

Mail clients allow the user to filter messages according to a threshold size. The entire mail box may be partially downloaded to the device. This kind of option is very useful when the user wants to defer the synchronization of the mailbox with the device until such time that another network with a broader bandwidth is available.

At present, the user can only do this operation manually. If the user fails to change the synchronization profile when a broader bandwidth is available, the filtering of the emails will continue even though it would have been possible to download them entirely without any size limitation.

In the same way, if the user fails to change the synchronization profile in order to filter the mail, entire downloading of the email though the new available network will occur. For example, for GPRS at a very narrow bandwidth this may be very time consuming. This will clearly give rise to many disadvantages that may be time consuming and costly.

### SUMMARY OF THE INVENTION

One object of the present invention is to overcome at least some of the problems associated with the prior art and provide an improved method and system for managing data transmission.

More particularly the present invention provides a method of managing data transmission comprising the steps of:
determining available network resources between a device and a remote server;
choosing a network resource from the available network resources with a bandwidth which is greater than a bandwidth of any other available network resource; and
communicating a synchronization profile to the device that matches the bandwidth of the chosen network so that a connection can be established.

More particularly the present invention discloses a system for managing data transmission comprising:
a system for determining available network resources between a device and a remote server;
a system for choosing a network resource from the available network resources with a bandwidth which is greater than a bandwidth of any other available network resource; and
a system for communicating a synchronization profile to the device that matches the bandwidth of the chosen network so that a connection can be established.

Advantages of the present invention are set out below. The mail sync adaptor will automatically configure the mail client with the highest bandwidth available near the device. This avoids the need for the user to manually change the selection of the bandwidth each time it is needed.

### BRIEF DESCRIPTION OF THE DRAWINGS

Reference will now be made, by way of example, to the accompanying drawings, in which:

FIG. 1 is a block diagram showing how a system mail client connects to a remote server;

FIG. 2 is a drawing showing the functionalities of the mail sync adaptor forming part of the system of FIG. 1; and

FIG. 3 is a flow chart showing the method of the present invention.

### DETAILED DESCRIPTION OF THE INVENTION

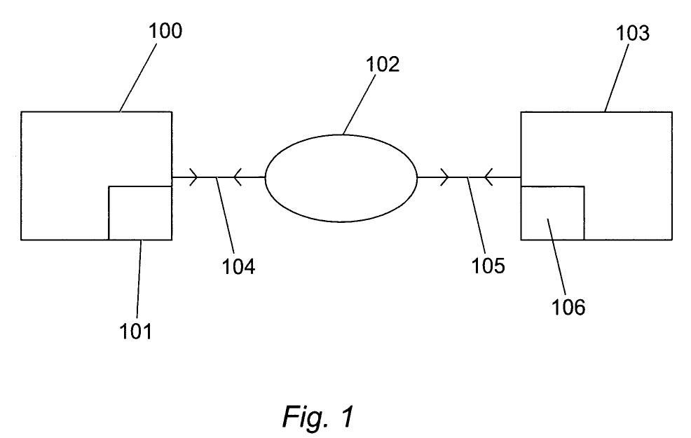

Referring to FIG. 1, a user (not shown) is using a device 100, for example a computer or laptop or personnel digital assistant, which has an e-mail application. The e-mail application includes a mail client 101. The mail client 101 may be any known mail system which includes a storage capability for e-mail, send and receive capabilities, connection to a server, etc.

The mail client 101 is able to connect to a network 102 via a connection 104. The network 102 is in turn connected via a connection 105 to a remote server 103. The connections may be effected in any appropriate manner or through a different medium than a network, as long as the device 100 may communicate with the remote server 103. The network connection enables access to a remote server 103 in order to download e-mails from a mail server 106 located on the remote server 103. It will be appreciated that the download of e-mails is one example of data which may be downloaded, but this invention may extend to any other sort of data, for example, video, telephone, documents, music or any other media or data.

The network connection may be of any known type, for example Ethernet, WiFi, ADSL, GPRS, Modem, etc. For each type of network connection there will be a different average maximum bandwidth as is well known in the art. The following list shows examples of several types of networks with an example average maximum value of bandwidth: Ethernet (100 Mb), WiFi (11 Mb), ADSL (2 Mb), GPRS (56 kb), and modem (56 kb).

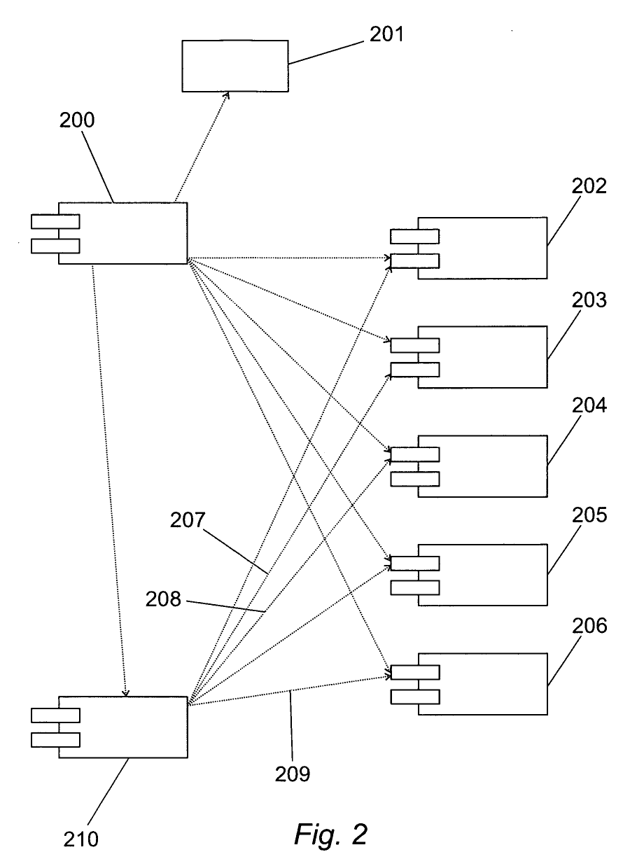

Referring now to FIG. 2, when the user wants to connect the device to the network the device will launch a network search to determine available network resources. The search is conducted in a known manner using a connection manager 200. This search will look for network resources, for example Ethernet 202, WiFi 203, ADSL 204, GPRS 205 and Modem 206. The result of the search is a list of available resources that the device can connect to. The list will for example determine that there is a possible WiFi connection 207, a possible ADSL connection 208 and a possible Modem connection 209. The list of available resources will be transmitted to a mail sync adaptor 210. From the list of available resources the mail sync adaptor 210 will determine the resource with the greatest available bandwidth. In the above mentioned example this will be the WiFi connection 207, although in other examples the highest bandwidth resource may be different.

The mail sync adaptor 210 then consults a configuration “config” file 201, which may be in the device, the network, the remote server, or elsewhere. This “config” file 201 enables the device to configure itself with the synchronization protocol which matches the network resource which has the highest available bandwidth. In the above mentioned example this will be WiFi. Once the correct synchronization profile is selected and loaded on the device the user will be able to access e-mails or other data using the highest available bandwidth resource, in this case the WiFi connection 207. This will ensure that download of any data will be optimized in terms of time taken for the download to occur.

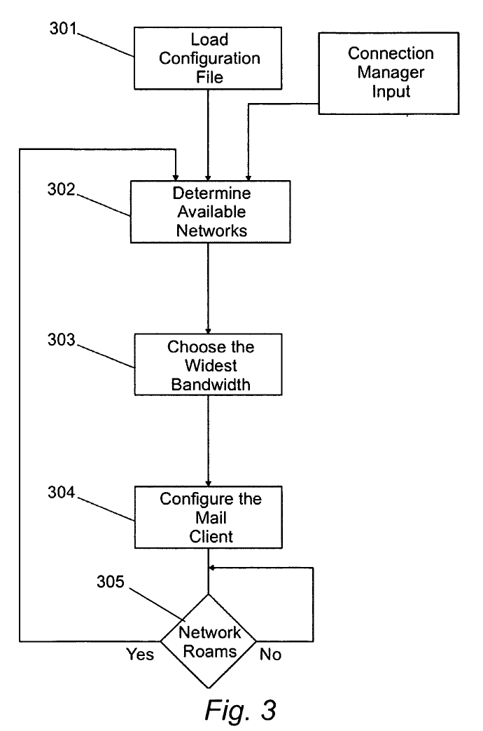

The different steps of the process of this invention are shown with reference to FIG. 3. The file containing the matching list between synchronization profile and network bandwidths is loaded to the user device, step 301. Assuming the connection has determined the available network resources the mail sync adaptor will determine which network resources are available at the present time, step 302. The mail sync adaptor will then choose the network with the widest bandwidth out of the available resources, step 303. The matching synchronization profile of the chosen network is then communicated to the device, so that connection can be made, step 304. If the connection is established and for as long as necessary a poll may be made by the device, step 305, to determine if it is necessary to “network roam” and find another connection, i.e., the chosen network connection has terminated for one reason or another. If the network roam is not needed (answer NO) the chosen connection continues and no further action is taken until the next poll. If network roam is needed (answer YES) the process returns to step 302 and determines again from a connection manager the available resources and the flow of steps is repeated. The frequency at which polling occurs can vary from one situation to the next and may occur more often if a low bandwidth is available, in order to ensure connection to the broadest possible bandwidth. Indeed, the polling may occur at any time not just if the connection is terminated in order to find a broader bandwidth resource.

While the invention has been particularly shown and described with reference to a preferred embodiment, it will be understood that various changes in form and detail may be made therein without departing from the spirit, and scope of the invention.

1. A method of managing data transmission comprising the steps of:
determining available network resources between a device and a remote server;
choosing a network resource from the available network resources with a bandwidth which is greater than a bandwidth of any other available network resource; and
communicating a synchronization profile to the device that matches the bandwidth of the chosen network so that a connection can be established.

2. The method of claim 1, further comprising establishing a connection between the device and the remote server.

3. The method of claim 1, further comprising the step of searching for available network resources in order to find another connection if the chosen network resource becomes unavailable.

4. The method of claim 1, further comprising downloading data from the remote server to the device.

5. The method of claim 4, further comprising downloading emails to a mail client in the device.

6. A system for managing data transmission comprising:
a system for determining available network resources between a device and a remote server;
a system for choosing a network resource from the available network resources with a bandwidth which is greater than a bandwidth of any other available network resource; and
a system for communicating a synchronization profile to the device that matches the bandwidth of the chosen network so that a connection can be established.

7. The method of claim 6, further comprising a system for establishing a connection between the device and the remote server.

8. The system of claim 6, further comprising a system for searching for available network resources in order to find another connection if the chosen network resource becomes unavailable.

9. The system of claim 6, further comprising a system for downloading data from the remote server to the device.

10. The system of claim 9, wherein the system for downloading data is configured to download emails to a mail client in the device.

11. A computer program for managing data transmission comprising instructions for carrying out the steps of:
determining available network resources between a device and a remote server;
choosing a network resource from the available network resources with a bandwidth which is greater than a bandwidth of any other available network resource; and
communicating a synchronization profile to the device that matches the bandwidth of the chosen network so that a connection can be established.
